(19) United States
(12) Patent Application Publication
(10) Pub. No.: US 2010/0242607 A1
(43) Pub. Date: Sep. 30, 2010

(54) INSPECTION METHOD FOR DETERMINING A LOCATION OF INCIPIENT DAMAGE

(75) Inventors: Ramkumar Kashyap Oruganti, Bangalore (IN); Michael Francis Xavier Gigliotti, JR., Scotia, NY (US); Edward James Nieters, Burnt Hills, NY (US); Sivaramanivas Ramaswamy, Bangalore (IN); Ganesan Baskaran, Bangalore (IN); Balachandar Ramadurai, Bangalore (IN)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, SCHENECTADY, NY (US)

(21) Appl. No.: 12/409,581

(22) Filed: Mar. 24, 2009

(51) Int. Cl. G01N 29/04

(52) U.S. Cl. 73/579; 73/602

(57) ABSTRACT

A method for determining a location of incipient damage of an object comprises insonifying the object at a plurality of locations using ultrasonic signals during an inspection, acquiring signals indicative of a possible damage condition from the plurality of locations of the insonified object in said inspection, determining a value for each of the locations to indicate accumulated damage by mathematically combining the acquired signals from said inspection and at least a portion of prior inspections, and comparing the values of the plurality of locations to determine a location indicating possible incipient damage.

### BACKGROUND

The subject matter disclosed herein relates generally to non-destructive ultrasonic testing methods and, more particularly, to an ultrasonic inspection method for determining locations of incipient damage such as mechanical failure.

One of the important applications of non-linear ultrasound (NLU) is in inspection of operating parts for any signs of damage. High frequency ultrasonic signals at a fundamental frequency are transmitted toward an area of interest. Any damage or irregularity in the path of the transmitted ultrasonic signals will generate harmonic components of the fundamental frequency. The fundamental frequency component and harmonic components are received and analyzed to assess the condition of the part for signs of incipient damage. Based on the inspection data, the part can be repaired or withdrawn from service.

A part can be inspected at different stages of its operating life. At each stage, the part is inspected to determine signs of incipient damage. Suitable inference such as identifying location of damage would be made based on the inspection conducted at a particular stage. But a part undergoes alternating softening and hardening and the incremental increase between inspections can be very small. Therefore, relying on results from a single inspection will not be conclusive and can be misleading. Also, failures happen when damage localizes and accumulates in one location. A single inspection would not be able to identify this accumulated damage condition.

It would therefore be desirable to provide an inspection methodology to effectively determine a location of incipient damage by capturing damage accumulation.

### BRIEF DESCRIPTION

In accordance with one embodiment disclosed herein, a method for determining a location of incipient damage of an object comprises insonifying the object at a plurality of locations using ultrasonic signals during an inspection, acquiring signals indicative of a possible damage condition from the plurality of locations of the insonified object in said inspection, determining a value for each of the locations to indicate accumulated damage by mathematically combining the acquired signals from said inspection and at least a portion of prior inspections, and comparing the values of the plurality of locations to determine a location indicating possible incipient damage.

In accordance with another embodiment disclosed herein, a method for determining a location of incipient damage of an object comprises insonifying the object at a plurality of locations using ultrasonic signals during an inspection, acquiring signals indicative of a possible damage condition from the plurality of locations of the insonified object in said inspection, averaging the acquired signals from said inspection and at least a portion of prior inspections corresponding to their respective locations to have a cumulative average for each of the locations, and comparing the cumulative averages of the plurality of locations to determine a location indicating possible incipient damage.

In accordance with another embodiment disclosed herein, a non-linear ultrasound inspection method for determining a location of incipient damage of an object comprises insonifying the object at a plurality of locations using ultrasonic signals at a fundamental frequency during an inspection, acquiring signals indicative of a possible damage condition from the plurality of locations of the insonified object in said inspection, averaging the acquired signals from said inspection and at least a portion of prior inspections corresponding to their respective locations to have a cumulative average for each of the locations, and comparing the cumulative averages of the plurality of locations to determine a location indicating possible incipient damage. The acquired signals comprise the fundamental frequency and a harmonic component of the fundamental frequency.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram illustrating a method for determining a location of incipient damage of an object in accordance with aspects disclosed herein.

FIG. 2 illustrates an exemplary inspection set-up in accordance with aspects disclosed herein.

FIG. 3 is a table illustrating data processing for an inspection in accordance with aspects disclosed herein.

FIG. 4 is a graphical representation of cumulative averages of various locations of the object at different inspections in accordance with aspects disclosed herein.

### DETAILED DESCRIPTION

Embodiments disclosed herein include an inspection method for determining locations of incipient damage or mechanical failure. Briefly stated, the inspection method first includes insonifying the object at a plurality of locations using ultrasonic signals during an inspection. Signals indicative of a possible damage condition are then acquired from the plurality of locations of the insonified object in said inspection. A value to indicate accumulated damage is determined for each of the locations using the acquired signals from said inspection and prior inspections. The values of the plurality of locations are then compared to determine a location indicating possible incipient damage. As used herein, singular forms such as “a,” “an,” and “the” include plural referents unless the context clearly dictates otherwise.

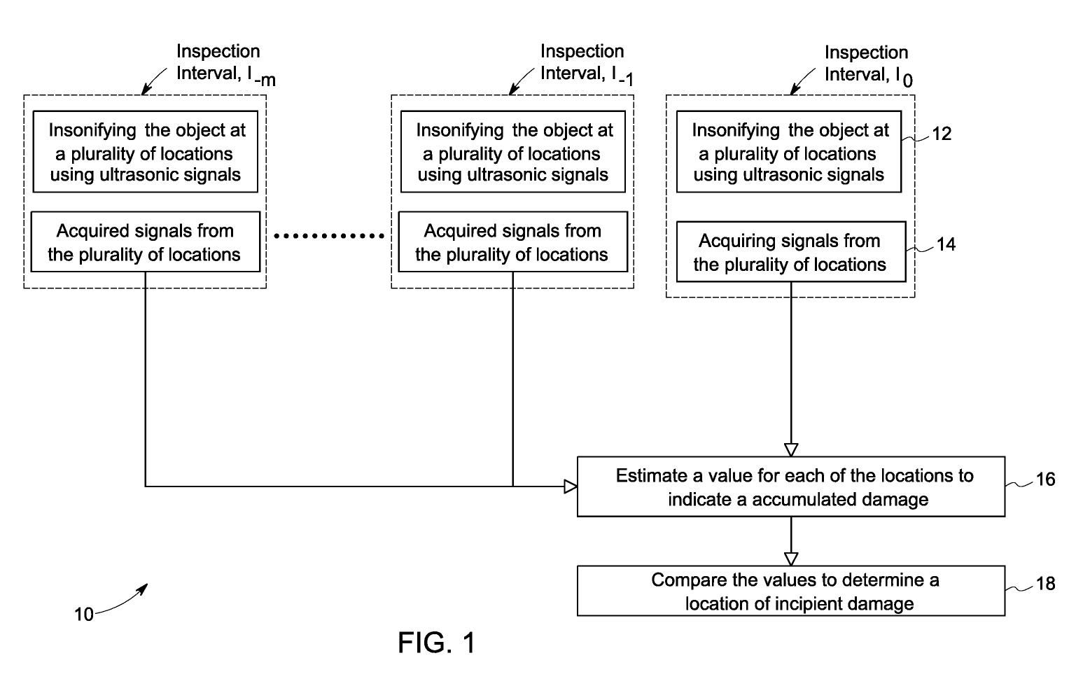

FIG. 1 illustrates a block diagram of a method 10 for determining a location of incipient damage of an object. In one embodiment, the inspection method is based on non-linear ultrasound. At an inspection I₀, an object is insonified at a plurality of locations at block 12. Ultrasonic signals at a fundamental frequency are used to insonify the object. Signals generated in response to the incident ultrasonic signals are acquired from each of the plurality of locations at block 14. The acquired signals include signals at fundamental frequency and a harmonic component of the fundamental frequency. At block 16, a value for each of the locations to indicate accumulated damage is determined by mathematically combining the acquired signals from inspection I₀ and at least a portion of prior inspections at I₋₁ to I₋ₘ. Mathematically combining refers to using mathematical techniques such as, but not limited to, weighted average, multiplication, cumulative average, or any combinations thereof.

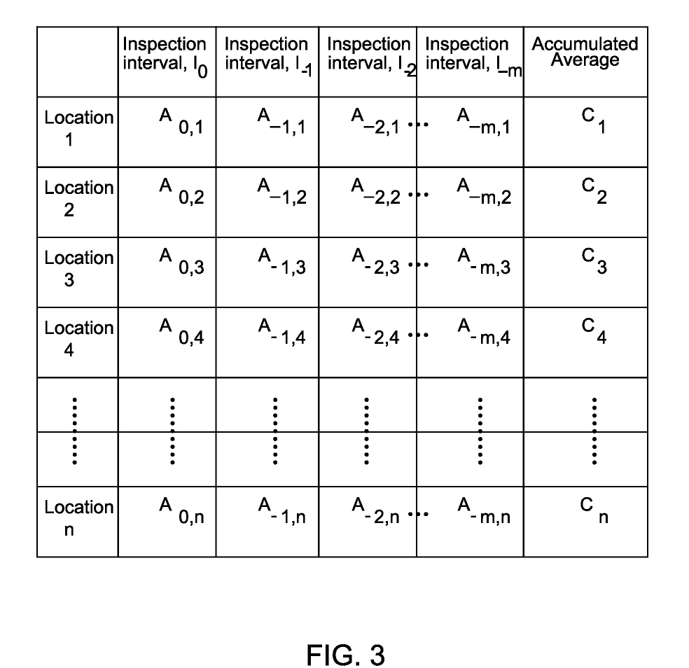

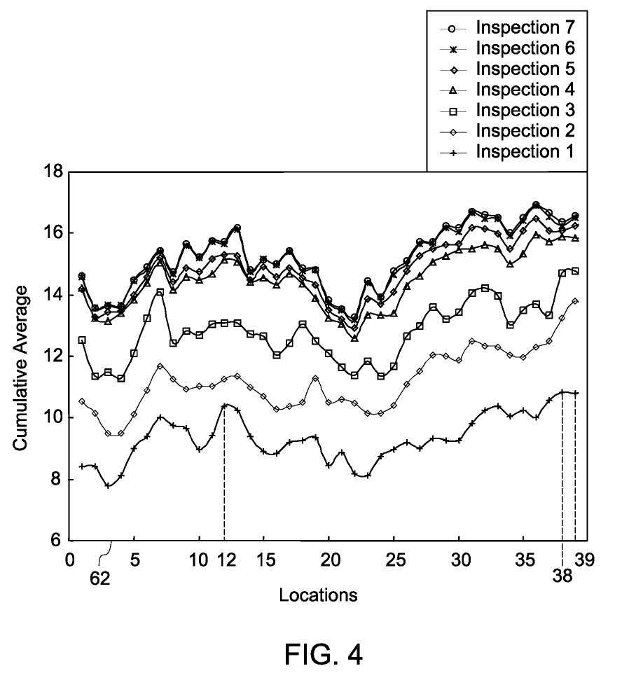

The values of all the locations are compared at block 18 to determine a location indicating possible incipient damage. In one embodiment, the value includes a cumulative average. The acquired signals for each of the locations are averaged over an inspection I₀ and all prior inspections I₋₁ to I₋ₘ to have a cumulative average for each of the locations on the object. The acquired signals indicate extent of a damage condition. Therefore, accumulated damage at a particular location can be indicated by cumulative average. A higher value of cumulative average indicates a possible incipient damage. The detailed process of determining a location of incipient damage will be explained in reference to FIGS. 3 and 4.

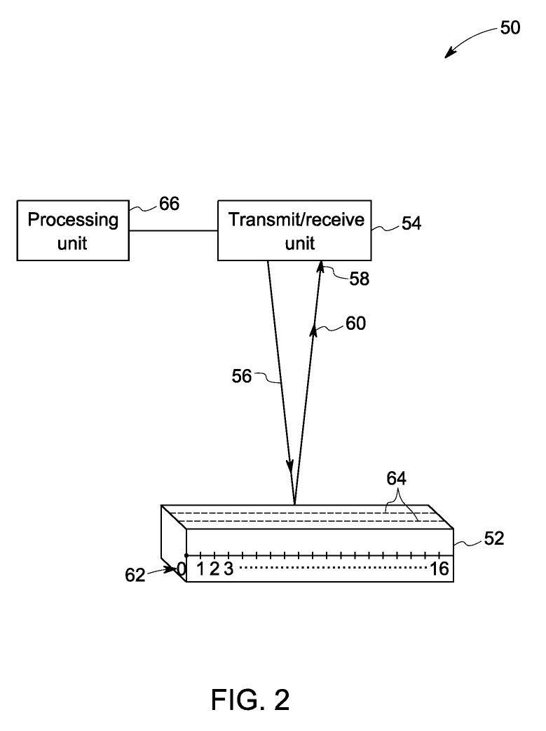

FIG. 2 illustrates an exemplary ultrasonic inspection set-up 50. In one embodiment, the set-up 50 is an immersion-based ultrasonic inspection set-up with the object 52 to be inspected inside a liquid medium (not shown) such as water. The set-up mainly includes a transmit/receive unit 54 to insonify an object using ultrasonic signals and to acquire signals generated in response to the incident ultrasonic signals. Those skilled in the art will recognize that various systems such as, but not limited to, transducers, tweeters, and similar acoustic devices along with associated electrical/mechanical connections can be used for the transmit/receive unit 54.

The transmit/receive unit 54 insonifies the object by transmitting ultrasonic signals at fundamental frequency f₀ 56. The object 52 is insonified at a plurality of locations. In response to the incident signals at fundamental frequency 56, signals at fundamental frequency 58 and harmonic components 60 of the fundamental frequency are generated. The transmit/receive unit acquires signals at fundamental frequency 58 and at least one harmonic component 60 of the fundamental frequency. In one embodiment, signals are acquired as a ratio of amplitudes of the fundamental frequency component f₀ 58 and the second harmonic component 2f₀ 60. In another embodiment, the acquired signal comprises ratio of the amplitude “A(2f₀)” of the second harmonic component 60 to the square of the amplitude “A(f₀)” fundamental frequency component f₀ 58.

Locations 62 on the object can be selected in several ways depending on the size, shape, and design of the object. For example, for the object 52 shown in FIG. 2, locations 62 can be represented as the distance from the left end of the object 52 as a reference point. For exemplary purposes, these plurality of locations 62 are shown on the object 52, with location ‘0’ being the left end of the object, location ‘1’ being at a distance of ‘x’ units away from location ‘0’, and location ‘2’ being at a distance of ‘2×’ units away from location ‘0’ and so on. The object 52 can be insonified at any number of locations 62. The object 52 is insonified at each of these locations 62 and signals 58 and 60 are acquired for each of these locations 62. Other reference points such as center of an object, right end of the object, periphery of the object can be selected depending on the size, shape, and design of the object.

An inspection can include multiple inspection trials. A single inspection trial includes the process of insonifying the object 52 at plurality of locations 62 (for example, 1 to 16) and acquiring signals corresponding to the plurality of locations 62. Inspection trials can be performed on all sides the object 52. Inspection trials can also be performed along several lines 64 on the same side of the object for the plurality of locations 62. The acquired signals from all the inspection trials of an inspection are corresponded to the locations 62 and are averaged to have an average for each of the locations 62.

The averages of acquired signals for each of the locations 62 obtained during an inspection are stored in a processing unit 66. At an inspection, the processing unit 66 calculates a cumulative average of the acquired signals for each of the locations 62. The cumulative average is calculated by averaging the acquired signals from a current inspection and prior inspections corresponding to their respective locations 62.

Since the amplitude of the harmonic components can be related to damage condition, the magnitude of the acquired signals, and hence the magnitude of cumulated average, is indicative of a damage condition and suitable inference about incipient damage can be drawn. Damage conditions can refer to micro-structural features, such as dislocations, that distort the input ultrasonic waves and give rise to harmonics. Examples of damage conditions include fatigue, creep, or creep-fatigue. Therefore, the processing unit 66 compares cumulative averages of the locations 62 and determines a location with relatively higher cumulated average that is indicative of possible incipient damage.

FIG. 3 illustrates an embodiment of the detailed procedure of data processing to calculate cumulative averages and determine a location of incipient damage. At each inspection, several inspection trials are conducted and the acquired signals are averaged for each of the locations. For example, at an inspection I₀, all the signals acquired corresponding to location ‘1’ are averaged to have an average that is represented as A_{0,1}, with ‘0’ in subscript representing the inspection number and ‘1’ in subscript representing the location number.

Inspection I₀ is assumed as a current inspection and prior inspections are represented as I₋₁, I₋₂, . . . , I₋ₘ. As another example, at an inspection I₋ₘ, all the signals acquired corresponding to location ‘n’ are averaged to have an average that is represented as A_{-m,n}, with ‘m’ in subscript representing the inspection and ‘n’ in subscript representing the location number.

At the inspection I₀, cumulative averages for each of the locations are calculated by averaging the acquired signals from the inspection I₀ and the prior inspections I₋₁ to I₋ₘ corresponding to their respective locations. For example, cumulative average “C₁” for location ‘1’ is calculated by the averaging A_{0,1}, A_{-1,1}, A_{-2,1}, . . . , A_{-m,1}. The cumulative averages “C₁, C₂, . . . , Cₙ” are then compared to determine a location with maximum cumulative average. As stated previously, the magnitude of the acquired signals, and hence the magnitude of cumulated average, is indicative of the extent of damage. Therefore, the location with maximum cumulative average indicates possible incipient damage compared to other locations.

FIG. 4 is a graphical interpretation of cumulative averages of various locations on an object at different inspections. As an example, data from seven inspections conducted at different operating cycles of the object is shown. At each inspection, cumulative averages are plotted against their respective locations 62. The first inspection ‘1’ does not have cumulative averages. Locations ‘12’, ‘38’, and ‘39’ indicate higher values compared to other locations. Subsequent inspections include cumulative averages.

As the number of inspections increase, the accumulated damage is more conclusively represented by the cumulative average. For example, cumulative average at location ‘36’ gradually increases and is higher compared to other locations from inspection ‘4’. This kind of trend represents accumulated damage at location ‘36’ and therefore indicates possible incipient damage at location ‘36’ compared to other locations.

Relying on data from a single inspection, without using cumulative average, will not capture this trend of accumulated damage. A higher value of an acquired signal from a single inspection may not be conclusively taken as a sign of accumulated damage.

The inspection method described above thus provides a way to conclusively determine a location of incipient damage of an object by capturing accumulated damage over several inspections. The method suppresses spikes or any unusual data from a single inspection that may lead to inappropriate conclusions. Once a location of possible incipient damage is determined, the object can be salvaged before further damage such as crack initiation, leading to significant cost savings. The object can be repaired using various processes, such as, but not limited to, brazing and laser powder deposition. Therefore, the service life of an object can be extended.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for determining a location of incipient damage of an object, comprising:
insonifying the object at a plurality of locations using ultrasonic signals during an inspection;
acquiring signals indicative of a possible damage condition from the plurality of locations of the insonified object in said inspection;
determining a value for each of the locations to indicate accumulated damage by mathematically combining the acquired signals from said inspection and at least a portion of prior inspections; and
comparing the values of the plurality of locations to determine a location indicating possible incipient damage.

2. The method of claim 1, wherein insonifying the object at a plurality of locations using ultrasonic signals comprises insonifying the object at a plurality of locations using the ultrasonic signals at fundamental frequency.

3. The method of claim 2, wherein the acquired signals comprise a ratio of amplitudes of the fundamental frequency and a harmonic component of the fundamental frequency.

4. The method of claim 2, wherein the acquired signals comprise a ratio of amplitude of a second harmonic component to the square of amplitude of the fundamental frequency.

5. The method of claim 1, wherein the acquired signals comprise signals generated in response to the ultrasonic signals used to insonify the object.

6. The method of claim 1, wherein determining a value comprises:
determining a cumulative average for each of the locations by averaging the acquired signals from said inspection and said at least a portion of prior inspections corresponding to their respective locations.

7. The method of claim 6, wherein comparing the values comprises:
comparing the cumulative averages to determine a location with maximum cumulative average that indicates possible incipient damage.

8. The method of claim 1, wherein the magnitude of the acquired signals is indicative of extent of the damage condition.

9. The method of claim 1, wherein mathematically combining comprises weighted average, multiplication, cumulative average, or any combinations thereof.

10. The method of claim 1, wherein the damage condition comprises fatigue, creep, or creep-fatigue.

11. A method for determining a location of incipient damage of an object, comprising:
insonifying the object at a plurality of locations using ultrasonic signals during an inspection;
acquiring signals indicative of a possible damage condition from the plurality of locations of the insonified object in said inspections;
averaging the acquired signals from said inspection and at least a portion of prior inspections corresponding to their respective locations to have a cumulative average for each of the locations; and
comparing the cumulative averages of the plurality of locations to determine a location indicating possible incipient damage.

12. The method of claim 11, wherein insonifying the object at a plurality of locations using ultrasonic signals comprises insonifying the object at a plurality of locations using the ultrasonic signals at fundamental frequency.

13. The method of claim 12, wherein the acquired signals comprise a ratio of amplitudes of the fundamental frequency and a harmonic component of the fundamental frequency.

14. The method of claim 12, wherein the acquired signals comprise a ratio of amplitude of a second harmonic component to the square of amplitude of the fundamental frequency.

15. The method of claim 11, wherein the acquired signals comprise signals generated in response to the ultrasonic signals used to insonify the object.

16. The method of claim 11, wherein comparing the cumulative averages comprises: comparing the cumulative averages to determine a location with maximum cumulative average that indicates possible incipient damage.

17. The method of claim 11, wherein the magnitude of the acquired signals is indicative of extent of the damage condition.

18. The method of claim 11, wherein the damage condition comprises fatigue, creep, or creep-fatigue.

19. A non-linear ultrasound inspection method for determining a location of incipient damage of an object, comprising:
insonifying the object at a plurality of locations using ultrasonic signals at a fundamental frequency during an inspection;
acquiring signals indicative of a possible damage condition from the plurality of locations of the insonified object in said inspection, the acquired signals comprise the fundamental frequency and a harmonic component of the fundamental frequency;
averaging the acquired signals from said inspection and at least a portion of prior inspections corresponding to their respective locations to have a cumulative average for each of the locations; and
comparing the cumulative averages of the plurality of locations to determine a location indicating possible incipient damage.

20. The method of claim 19, wherein the acquired signals comprise a ratio of amplitudes of the fundamental frequency and the harmonic component of the fundamental frequency.

21. The method of claim 19, wherein the acquired signals comprise a ratio of amplitude of a second harmonic component to the square of amplitude of the fundamental frequency.

22. The method of claim 19, wherein comparing the cumulative averages comprises: comparing the cumulative averages to determine a location with maximum cumulative average that indicates possible incipient damage.

23. The method of claim 19, wherein the magnitude of the acquired signals is indicative of extent of the damage condition.

24. The method of claim 19, wherein the damage condition comprises fatigue, creep, or creep-fatigue.
